(19) United States
(12) Patent Application Publication
(10) Pub. No.: US 2016/0046037 A1
(43) Pub. Date: Feb. 18, 2016

(54) METHOD AND APPARATUS FOR REPAIRING EDGE DEFECTS IN BOARDS

(71) Applicant: RfsProtech, LLC, Matthews, NC (US)

(72) Inventors: Karl Ogden, Charlotte, NC (US); Russell Gordon Hass, North Wilkesboro, NC (US)

(21) Appl. No.: 14/459,688

(22) Filed: Aug. 14, 2014

(51) Int. Cl. B27M 3/04

(52) U.S. Cl. CPC B27M 3/04

(57) ABSTRACT

An apparatus for repairing an edge defect in an object such as a board, that includes a support for supporting the board and a dam cooperating with the support for being positioned against a side edge of the board at the location of the edge defect to enclose the defect. An application head is adapted for being positioned over the enclosed defect. At least one injection nozzle is carried by the application head for injecting a patch compound into a void defined by the enclosed defect.

### TECHNICAL FIELD AND BACKGROUND OF THE INVENTION

This invention relates to a method and apparatus for repairing edge defects such as knots and splits in boards, such as used in manufacturing wood flooring, wood cabinet components and wood furniture components. While the invention of this application is described with regard to wooden boards, the invention also has application in the repair of fabricated of other materials, such as resins, wood/filler composites and the like. The term “board” is used in this application in its broad sense to mean a thin, flat piece of wood or other relatively stiff material used for various purposes.

In the manufacture of various products using wooden boards such as used to manufacture flooring, plywood, and furniture it is necessary to repair defects in the boards such as knots and splits. These defects may occur inside the perimeter or along an edge of the board. Various automated machines and methods have been developed to automatically scan and repair boards. For example U.S. Pat. Nos. 4,984,172 and 4,614,555 disclose systems that utilize laser or electro-mechanical scanners to detect and qualify the defects and automated defect correction devices that include application of solid plugs and/or various fillers that repair the defect. These devices are typically automated, and are controlled along the X, Y and Z machine axes to detect and fill defects with minimal operator interaction.

However, these automated systems are not practical in situations that require repair of defects in a multitude of different board sizes, wood species and component types, such as found in the custom flooring, kitchen cabinet and furniture industries. These automated solutions are not practical because they require time-consuming setups and substantial capital investment. Recent advancements in thermoplastic materials have resulted in economical patching compounds such as polyamide-based materials and waxed-based hot melt materials that are applied by fully automated equipment and manual devices similar to those currently manufactured by the applicant and others. These products are characterized by rapid drying and/or curing with resulting excellent strength.

These manual devices suspend one or more application heads above a planar surface and automate the location of the application head in the Z-axis, i.e., the vertical direction only. The operator manually locates the board defects along the X and Y machine axis and manually positions the board defect below the application head. The operator then lowers the application head utilizing a foot switch or other means. The application head then injects the thermoplastic patching material into the defect under pressure, filling the defect. In this method, the defect is fully enclosed around its edge by sound material that restricts the pressurized liquid patching compound from escaping and provides sufficient time to allow the compound to cool and solidify, thus forming the patch. This method permits an operator to repair defects in wooden boards with a substantially reduced capital investment.

However, these manual methods and devices have not permitted the repair of defects that are located along the side edge of a board and thus are not surrounded by material that acts to enclose the pressurized patch material in the area of the defect. Since a significant percentage of defects occur along the side edges of the boards, there is a need for a method and apparatus that will permit the application of liquid patching compound to the side edges of boards as well as defects that are surrounded by a sound material in a manner permitting repair in a normal manner.

The present invention addresses the above needs and achieves other advantages by providing an apparatus and method for completing the enclosure of the side edge defect so that the patching compound can be forced under pressure into the defect. This apparatus can be easily configured to repair a wide variety of edge profiles and board thicknesses.

### SUMMARY OF THE INVENTION

It is therefore an object of the present invention to provide a method and apparatus for repairing side edge defects in materials such as boards, panels, plates and substrates.

It is another object of the invention to provide a method and apparatus for repairing side edge defects in wood.

It is another object of the invention to provide a method and apparatus for temporarily enclosing the perimeter of an edge defect to form enclosed opening into which a pressurized patching compound can be applied.

These and other objects and advantages of the invention are achieved by providing a method of repairing an edge defect in an object, including the steps of positioning the object with an edge defect on a support, enclosing an open side of the edge defect with an edge dam, positioning the edge defect under a supply of patch compound, applying patch compound into the object to fill the edge defect, and removing the edge dam.

According to one embodiment of the invention, the method includes the step of allowing the patch compound to harden before removing the dam.

According to another embodiment of the invention, the method includes the step of enclosing the edge defect includes urging the object against a fence whereby the edge defect and adjacent side edges of the object structure reside against the fence.

According to yet another embodiment of the invention, the step of applying the patch compound to the edge defect includes the step of injecting the patch compound from at least one injection nozzle into a void formed by a first peripheral vertical edge segment of the object and a second peripheral vertical edge segment defined by the dam.

According to yet another embodiment of the invention, the step of enclosing the edge defect with the edge dam includes the step of providing a fence having a vertically-oriented side edge that is vertically moveable between a lowered inoperative position and a raised operative position against which the object at the location of the edge defect is positioned.

According to yet another embodiment of the invention, the edge dam is removed by lowering the fence to the lowered, inoperable position.

According to yet another embodiment of the invention, the object is a board.

According to yet another embodiment of the invention, an apparatus for repairing an edge defect in an object is provided, and includes an object support for supporting the object and a dam cooperating with the object support for being positioned against the object at the location of the edge defect to enclose the defect. An application head is provided for being positioned over the enclosed defect. At least one injection nozzle is carried by the application head for injecting a patch compound into a void defined by the enclosed defect.

According to yet another embodiment of the invention, the dam includes a fence having a vertical wall positioned in an opening in the object support and movable between a lowered inoperative position and a raised operative position against which the object at the location of the edge defect is positioned.

According to yet another embodiment of the invention, the apparatus is adapted to repair edge defects in boards.

According to yet another embodiment of the invention, the application head includes an actuator for moving the injection nozzle vertically into and out of proximity with the edge defect in the object.

According to yet another embodiment of the invention, the application head includes an actuator for moving the injection nozzle forward and rearward in relation to the position of the object on the support.

According to yet another embodiment of the invention, the application head includes an actuator for moving the injection nozzle vertically into and out of proximity with the edge defect in the object and an actuator for moving the injection nozzle forward and rearward in relation to the position of the object.

According to yet another embodiment of the invention, the actuator for moving the injection nozzle vertically into and out of proximity with the edge defect in the object and the actuator for moving the injection nozzle forward and rearward in relation to the position of the object each comprise a pneumatic cylinder assembly.

According to yet another embodiment of the invention, the fence is movable between a lowered inoperative position and a raised operative position by an actuator.

According to yet another embodiment of the invention, the actuator for moving the fence between the lowered inoperative position and raised operative position is a pneumatic cylinder assembly.

According to yet another embodiment of the invention, an apparatus for repairing an edge defect in a board is provided, and includes a support table for supporting the board, and a fence having a vertical wall positioned in an opening in the support table and cooperating with the support table for being positioned against a vertical side edge of the board at the location of the edge defect to enclose the defect. An actuator is provided for moving the fence between a lowered inoperative position not above an upper surface of the support table and a raised operative position above the upper surface of the support table. An application head is adapted for being positioned over the board at the location of the enclosed defect. At least one injection nozzle is carried by the application head for injecting a patch compound into a void defined by the enclosed defect and includes an actuator for moving the injection nozzle vertically into and out of proximity with the edge defect in the board and an actuator for moving the injection nozzle forward and rearward in relation to the position of the board.

According to yet another embodiment of the invention, a pressure shoe is positioned for movement towards and away from the fence for capturing and holding the board in a stationary position against the fence during injection of the patch compound. The pressure shoe is moved by an actuator.

According to yet another embodiment of the invention, at least one infeed/outfeed table is positioned adjacent one side of the support table.

### BRIEF DESCRIPTION OF THE DRAWING FIGURES

The present invention is best understood when the following detailed description of the invention is read with reference to the accompanying drawings, in which:

FIG. 1 is a flow chart of a method of repairing edge defects according to one preferred embodiment of the invention;

FIG. 2 is an overall perspective view of an apparatus having an edge defect repairing capability in according with an embodiment of the present invention;

FIG. 3 is a perspective view of the support table and associated components of the apparatus shown in FIG. 2; and

FIG. 4 is a side view of the patch compound application head of the apparatus shown in FIGS. 2 and 3.

### DETAILED DESCRIPTION OF THE PREFERRED EMBODIMENT

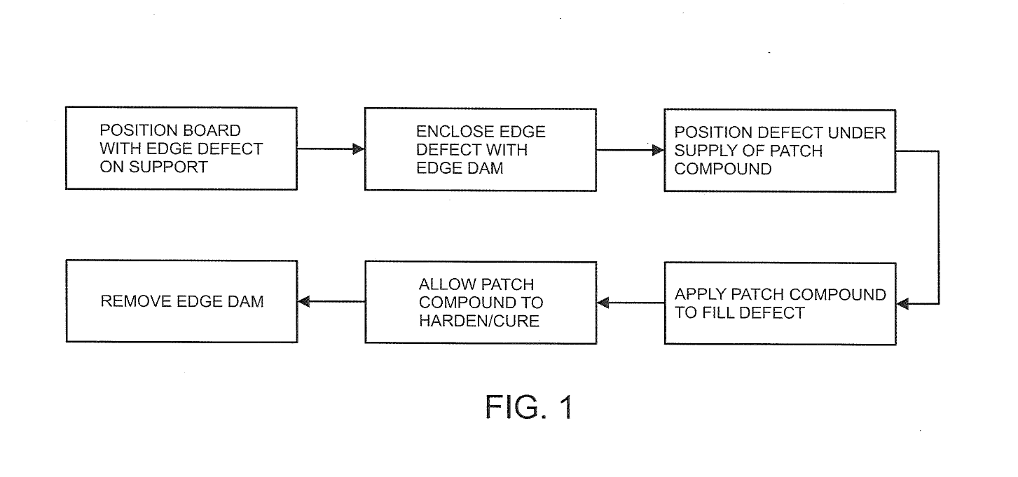

An edge defect patching method according to a preferred embodiment of the invention is shown in FIG. 1. The method broadly includes the steps of positioning an object, such as a board, with an edge defect to be repaired, on a support, and then in some manner using a structure to engage the board along its side edge so that the defect is enclosed with a dam to define an enclosed void. In this position, the defect is positioned under a supply of a patch compound, and the patch compound is introduced into the void of the defect. After the patch compound cures or hardens, the edge dam is removed, and the edge defect has been repaired.

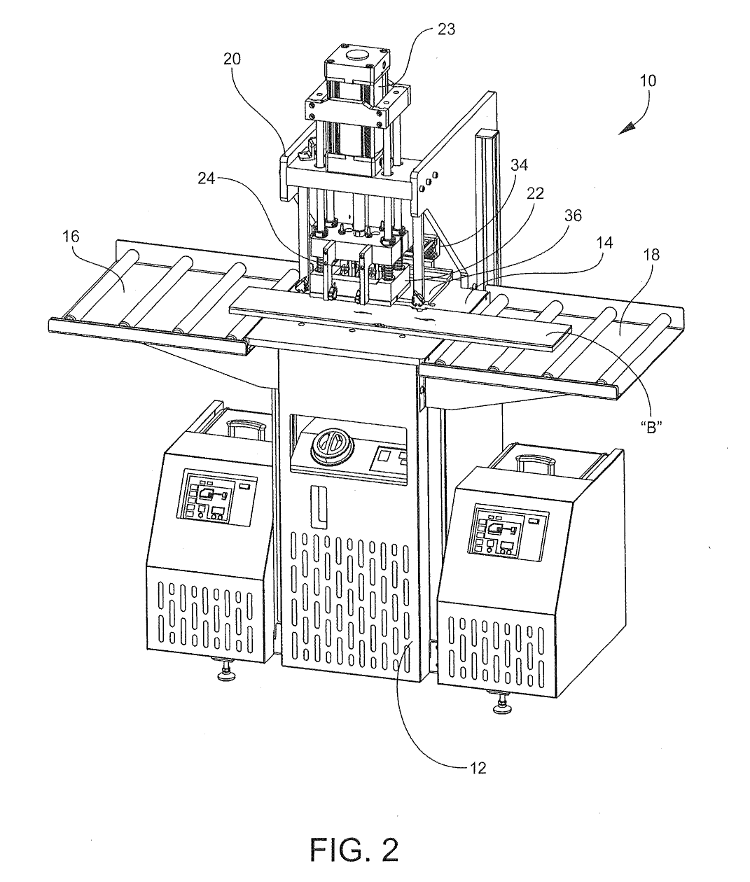

One preferred embodiment of an apparatus for repairing edge defects according to the method described above is shown in FIGS. 2-4 and indicated broadly at reference numeral 10. Apparatus 10 includes a base 12, a support table 14 on which a board “B” is supported in the vertical, or Z-axis, direction. The base 12 contains the machine controls, power supply, hoppers for storing and melting the patch compounds and similar components. Infeed/outfeed tables 16-18 permit boards “B” to be fed into and out of the apparatus 10 while being properly supported. Laser alignment elements may be used to precisely orient the edge defects of the board “B” relative to the other components.

An application head 20 is positioned on the base 12 for movement relative to the support table 14, and includes a top platen 22 operated by an actuator such as a top platen cylinder 23, and injection nozzle assembly 24. The injection nozzle assembly 24 may include a single or multiple nozzles. The injection nozzle assembly 24 includes a manifold that receives molten patch compound via a pump and an actuator that triggers discharge of the patch compound under the control of the operator.

The head 20 is moveable in three directions—vertically (Z-axis), laterally (X-axis) and forward/rearward (Y-axis). This arrangement permits defects within the perimeter of the board “B” and on an edge of the board “B” to be repaired. Lateral movement is accomplished by the operator, whereas vertical and forward and rearward movement is preferably accomplished by pneumatic cylinders, as described below.

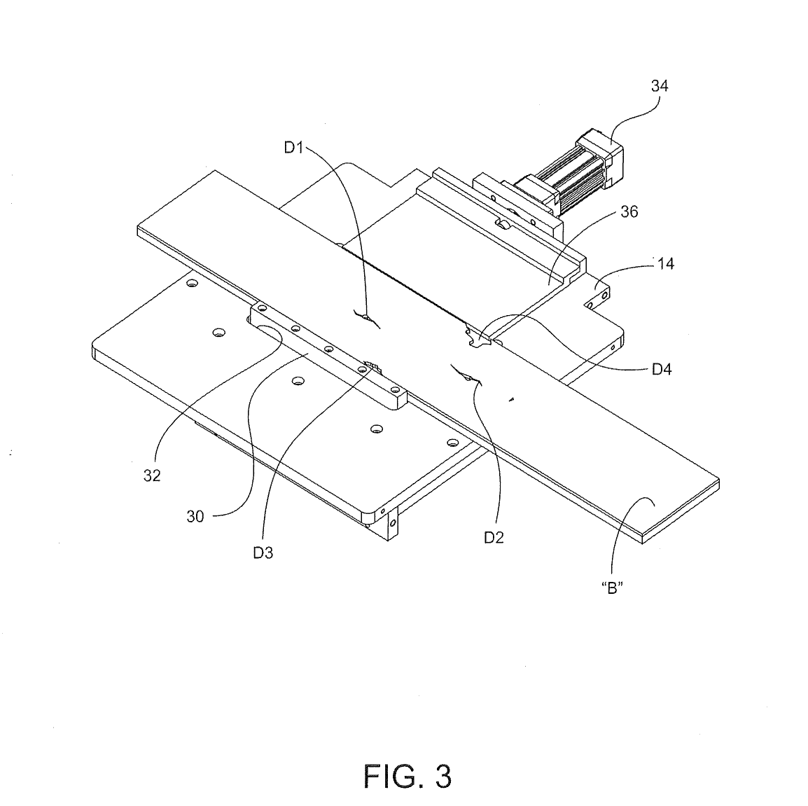

Referring now to FIG. 3, an indexing fence 30 is positioned in an opening 32 in the support table 14 and is moveable both vertically in the Z-axis direction and forward/rearward in the Y-axis direction. An optional horizontal cylinder 34 operates a pressure shoe 36 that can be used to urge the front edge of a board “B” against the indexing fence 30. As shown, the indexing fence 30 and the pressure shoe 36 can be used to for a temporary side edge, or “dam” to thereby fully enclose the edge defect. When defects within the perimeter of the board “B” are repaired, the indexing fence 30 can be lowered so that the defect can be positioned under the injection nozzle 24.

The indexing fence 30 is positioned so that the board “B” can be placed on either the forward or rear side of the fence 30 when being repaired. FIG. 3 shows the indexing fence 30 in the up position with a front edge defect located against the rear edge of the indexing fence 30.

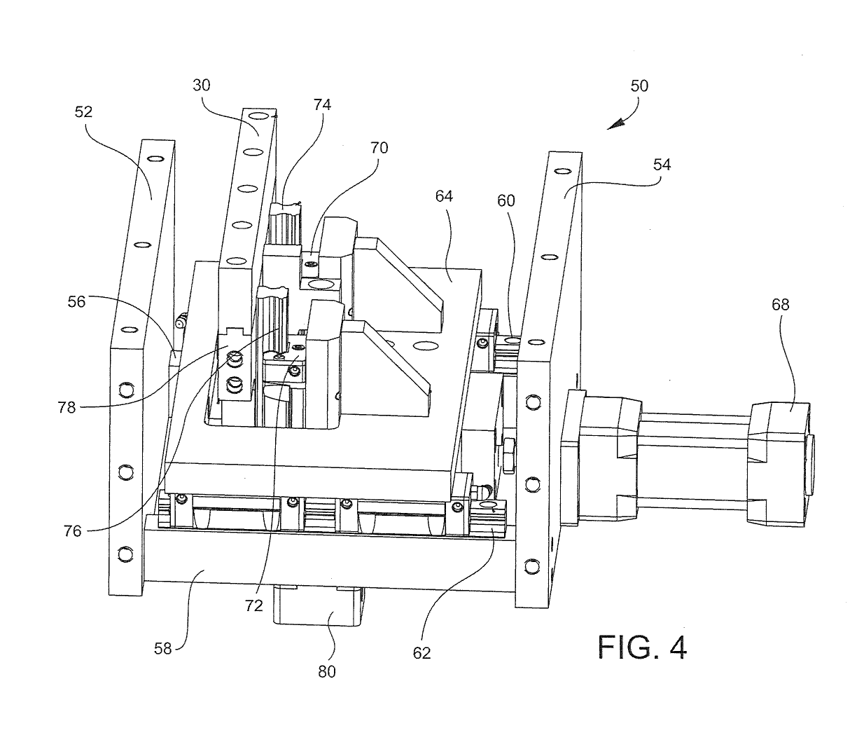

Referring now to FIG. 4, the indexing fence 30 is operated by a control mechanism 50 located under the support table 14. Vertical supports 52, 54 are rigidly fastened to the support table 14. Connector struts 56, 58 connect the vertical supports 52, 54. Horizontal linear rails 60, 62 are mounted between connector struts 56 and 58, respectively.

A horizontal indexing plate 64 is mounted to rails 60 and 62, as shown. The horizontal indexing plate 64 is positioned by operation of an actuator, such as a fence cylinder 68 in either a forward or rear position. Vertical linear bearings 70, 72 are attached to the horizontal indexing plate 64, and vertical linear rails 74, 76 are mounted to a fence support plate 78 and the linear bearings 70, 72, on which they ride in a vertically with one degree of freedom in the Z-axis direction. An actuator, such as a vertical pneumatic fence cylinder 80 is connected to the fence support plate 78 and indexes the fence 30 to either the up or down position.

In operation, an operator locates the board “B” manually in the X-axis and Y-axis directions to position a defect under the indexing top platen 22 and the injection nozzle 24. A foot switch, not shown, or other actuation means is used to energize the platen cylinder 23, which lowers the top platen 22 and the injection nozzle 24 onto the top of the board “B”, enclosing the defect. Molten patching compound is pumped to and applied by injection nozzle 24 into the defect, filling the void of the defect and effectuating the repair. After the patching compound cools and solidifies, the platen cylinder 23 de-energizes and raises top platen 22 and injection nozzle 24.

More specifically, when a board “B” with a defect within the perimeter of the board “B” is to be filled, for example, defects D1 and D2 of FIG. 3, the pneumatic fence cylinder 80 is indexed down, retracting the indexing fence 30 to a position below the surface of the support table 14. The operator locates a defect, for example, D1, beneath the injection nozzle 24 and engages the platen cylinder 23. Defect D2 is repaired in the same manner.

When a board “B” with an edge defect such as D3 on the front side of the board “B” is to be repaired, the pneumatic fence cylinder 80 is indexed up, raising the indexing fence 30 to a position above the surface of the support table 14. This position is shown in FIG. 3. Fence horizontal cylinder 68 indexes forward and positions the rear edge of indexing fence 30 directly below the injection nozzle 24. The operator aligns the defect D3 laterally along the X axis below the injection nozzle 24 and engages the platen cylinder 23. Patch compound is injected into the void of the defect D3, with the edge of the indexing fence 30 acting as a dam to fully enclose the perimeter of the defect D3. After the patching compound cools and solidifies, the platen cylinder 23 is de-energized, and raising the top platen 22 and injection nozzle 24 into an inoperative position. The indexing fence 30 may optionally be lowered, or it may be kept in the up position if the next defect is also an edge defect.

When a board “B” with an edge defect on the rear side, such as D4, is to be repaired, the pneumatic fence cylinder 80 is indexed up, raising the indexing fence 30 to a position above the surface of the support table 14. The fence horizontal cylinder 68 indexes rearward and positions the front edge of indexing fence 30 directly below the injection nozzle 24. The operator aligns the defect D4 laterally along the X axis below the injection nozzle 24 and then engages platen cylinder 23. After the patching compound cools and solidifies, the platen cylinder 23 is de-energized, and raising the top platen 22 and injection nozzle 24 into an inoperative position. The indexing fence 30 may optionally be lowered, or it may be kept in the up position if the next defect is also an edge defect.

A method and apparatus for repairing edge defects such as knots and splits in boards, such as wood flooring according to the invention have been described with reference to specific embodiments and examples. Various details of the invention may be changed without departing from the scope of the invention. Furthermore, the foregoing description of the preferred embodiments of the invention and best mode for practicing the invention are provided for the purpose of illustration only and not for the purpose of limitation, the invention being defined by the claims.

I/we claim:

1. A method of repairing an edge defect in an object, including the steps of:
(a) positioning the object with an edge defect on a support;
(b) enclosing an open side of the edge defect with an edge dam to define an enclosed void;
(c) positioning the edge defect under a supply of patch compound;
(d) applying patch compound into the void to fill the edge defect; and
(e) removing the edge dam.

2. The method of claim 1, and including the step of allowing the patch compound to harden before removing the dam.

3. The method of claim 1, wherein the step of enclosing the edge defect comprises urging the object against a fence whereby the edge defect and adjacent side edges of the object structure resides against the fence.

4. The method of claim 1, wherein the step of applying the patch compound to the edge defect comprises the step of injecting the patch compound from at least one injection nozzle into the void formed by a first peripheral vertical edge segment defined by the object and a second peripheral vertical edge segment defined by the dam.

5. The method of claim 1, wherein the step of enclosing the edge defect with the edge dam comprises providing a fence having a vertically-oriented side edge that is vertically moveable between a lowered inoperative position and a raised operative position against which the object at the location of the edge defect is positioned.

6. The method of claim 5, wherein the edge dam is removed by lowering the fence to the lowered, inoperable position.

7. The method according to claim 1, wherein the object is a board.

8. An apparatus for repairing an edge defect in an object, comprising:
(a) an object support for supporting the object;
(b) a dam cooperating with the object support for being positioned against the side edge of the object at the location of the edge defect for enclosing an open side of the edge defect to define an enclosed void;
(c) an application head for being positioned over the enclosed void; and
(d) at least one injection nozzle carried by the application head for injecting a patch compound into a void defined by the enclosed defect.

9. An apparatus according to claim 8, wherein the dam comprises a fence having a vertical wall positioned in an opening in the object support and movable between a lowered inoperative position and a raised operative position against which the object at the location of the edge defect is positioned.

10. An apparatus according to claim 8, wherein the apparatus is adapted to repair side edge defects in boards.

11. An apparatus according to claim 8, wherein the application head includes an actuator for moving the injection nozzle vertically into and out of proximity with the edge defect in the object.

12. An apparatus according to claim 8, wherein the application head includes an actuator for moving the injection nozzle forward and rearward in relation to the position of the object on the support.

13. An apparatus according to claim 8, wherein the application head includes an actuator for moving the injection nozzle vertically into and out of proximity with the edge defect in the object and an actuator for moving the injection nozzle forward and rearward in relation to the position of the object.

14. An apparatus according to claim 13, wherein the actuator for moving the injection nozzle vertically into and out of proximity with the edge defect in the object and the actuator for moving the injection nozzle forward and rearward in relation to the position of the object each comprise a pneumatic cylinder assembly.

15. An apparatus according to claim 9, wherein the fence is movable by an actuator between a lowered inoperative position and a raised operative position.

16. An apparatus according to claim 15, wherein the actuator for moving the fence between the lowered inoperative position and raised operative position is a pneumatic cylinder assembly.

17. An apparatus for repairing a side edge defect in a board, comprising:
(a) a support table for supporting the board;
(b) a fence having a vertical wall positioned in an opening in the support table and cooperating with the support table for being positioned against a vertical side edge of the board at the location of the edge defect to form a void, and including an actuator for moving the fence between a lowered inoperative position not above an upper surface of the support table and a raised operative position above the upper surface of the support table;
(c) an application head for being positioned over the board at the location of the void, and
(d) at least one injection nozzle carried by the application head for injecting a patch compound into the enclosed defect defining the void, and including an actuator for moving the injection nozzle vertically into and out of proximity with the edge defect in the board and an actuator for moving the injection nozzle forward and rearward in relation to the position of the board.

18. An actuator according to claim 17, and including a pressure shoe positioned for movement towards and away from the fence for capturing and holding the board in a stationary position against the fence during injection of the patch compound.

19. An actuator according to claim 18, wherein the pressure shoe is moved by an actuator.

20. An actuator according to claim 17, and including at least one infeed/outfeed table positioned adjacent one side of the support table.
